(19) United States
(12) Patent Application Publication
(10) Pub. No.: US 2010/0299097 A1
(43) Pub. Date: Nov. 25, 2010

(54) METHOD AND SYSTEM FOR TESTING, RECORDING, MONITORING, AND TRACKING THE CONTENTS OF SEALED REFUSE BALES

(76) Inventors: William T. Threlkeld, (US); Douglas Kinchley, (US)

Correspondence Address: William T Threlkeld, 8179 Bob O Link Drive, West Palm Beach, FL, 33412, US

(21) Appl. No.: 12/781,311

(22) Filed: May 17, 2010

Related U.S. Application Data
(60) Provisional application No. 61/179,002, filed on May 17, 2009.

(51) Int. Cl. G06F 15/00; G06F 17/30

(52) U.S. Cl. 702/127; 707/802; 707/E17.044

(57) ABSTRACT

This invention is a method and system for recording, monitoring, and tracking the contents of refuse bales. All refuse bale information is locally and remotely accessible. This method prevents the circulation of hazardous waste and undesirable materials without effecting baling efficiency. Bale attributes are updateable allowing for long distance and highly informative tracking.

### CROSS-REFERENCE TO RELATED APPLICATIONS

Provisional Patent Application No. 61/179,002

### BACKGROUND

This relates to a method and system for recoding and tracking the contents of sealed refuse and bales. The contents of said sealed bales can include but is not limited to: domestic refuse, bio-refuse, refuse-derived fuel, sewage slurry, biomass, old paper, old clothes, plastics, and a mixture of these materials. Due in large part to environmental and economical concerns, the management of trash and refuse disposal has become very important. As a given population increases, the amount of trash generated also increases. This situation is complicated by the fact that the public demand for disposable goods is seemingly insatiable. Even if a given population were to remain constant in number, the amount of trash generated by that population continues to increase. This increasing waste output coupled with overuse of landfills, limited land availability, and environmental concerns have forced corporations and municipalities to explore alternative methods of transporting and disposing of waste. One popular method of waste management is the packing of waste into sealed bales. One example of such a baling apparatus can be found in U.S. Pat. No. 5,784,856 to Altvater (1998).

The packing of waste or biomass into sealed bales prevents seepage, gas escape, decomposition, decreases overall volume, and eliminates transportation issues. Sealed bales can be transported longer distances for less money when compared with conventional methods of waste or biomass transport. Bailing and sealing technology is also advantageous to waste-to-energy or biomass-to-energy facilities because of the caloric preservation and easy independent onsite storage offered by this technology.

Despite the numerous advantages of bailing and sealing technologies there are two issues that arises when this technology is put into practice. The first is that there is no way of knowing what is inside a sealed bale without tearing it open and hindering the form and functionality of said sealed bale. The increased transportability creates a need for a method of tracking said sealed bales

Insofar as we are aware, no system and method for recording and tracking the contents of sealed biomass and refuse bales has ever been developed.

### SUMMARY

In response to the issues of contents identification and traceability surrounding bailing and sealing technology we have developed the first ever method of recording and tracking the contents of sealed refuse and biomass bales. The applications and advantages of this process can be understood from a study of the following description and accompanying drawings.

### DRAWINGS—FIGURES

FIG. 1 is a process/workflow diagram of incoming refuse/material data being captured, stored in database, assigned identification and flagged if necessary.

FIG. 2 is a process/workflow diagram of bale information being accessed remotely, updated, merged and appended.

### DRAWINGS—REFERENCE NUMERALS

10 raw sensor data

11 time stamp data operation

12 assign unique identification number

13 local database

14 local server

15 local work station

16 local operational information

17 wide area network or comparable means of networking

18 remote central database

19 remote workstation

20 alternative search field

21 retrieve bale data matching field of search

22 display bale data search results

23 update new operational information

24 display updateable operational info

25 unique identification number

26 barcode reader

27 refuse/material sealed bale labeled with barcode or unique identification number

28 Do you wish to update operational information?

29 Remote server

30 merge

31 loose refuse/material

32 baling apparatus

33 completed sealed refuse/material bale

34 digital video device/devices (may be focused on refuse/material, duping location, and employ location)

35 material analysis sensor/sensors (may include but is not limited to gas sensors and solvent sensors)

36 baling commencement and completion indicator

37 apply unique identification number to bale via barcode or comparable label

38 filter data and pass or tag that data

39 raw video data

### DETAILED DESCRIPTION

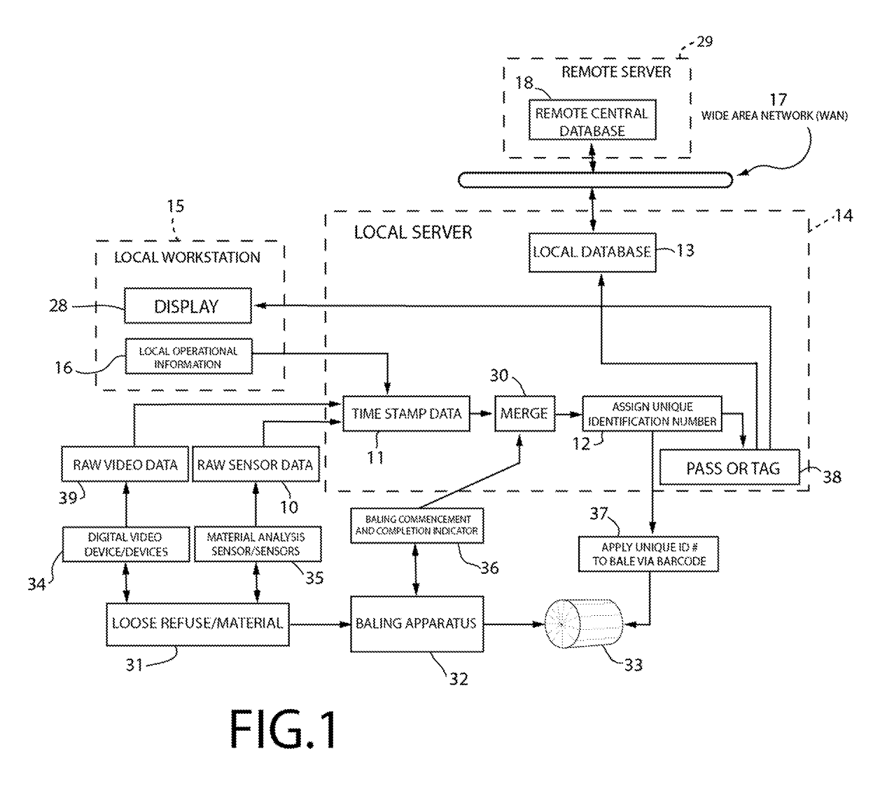

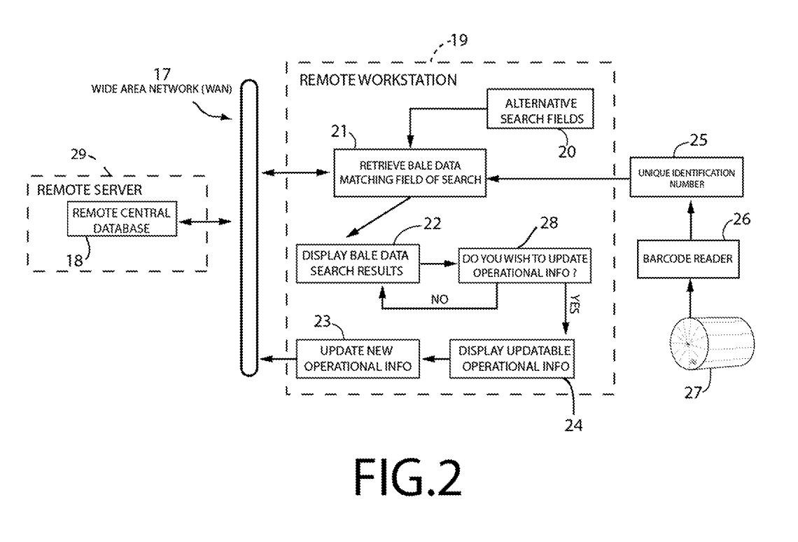

FIG. 1 contains one embodiment of our method of refuse/material data capture, refuse/material monitoring, bale data storage, bale data filtering, and bale contents identification. In FIG. 1 loose refuse/material 31 that is being fed into bailing apparatus 32 is observed by the digital video device/devices 34 and analyzed by material analysis sensor/sensors 35. The raw data 39 and 10 generated by the devices and sensors 34 and 35 is fed into a local server 14 along with local operational information 16. The local operational information is manually or automatically entered from a local work station 15 this information can include but is not limited to waste supplier origin, initial baling origin, operator/operators present, current date, and current time. All data and information can be transmitted through hard wire or wireless devices. All processes taking place within the local server and local workstation are carried out by specialized software. Incoming data 39, 10 and 16 enters the local server and is time stamped 11. The baling commencement and completion indicator 36 informs the local server when each bale 33 begins forming and when it 33 is finally completed. Using the information from the commencement and completion indicator 36 the local server 14 merges all data that was recorded during the formation of each bale 33. Merged data 30 is assigned a unique identification number 12. This newly identified data 30 and 12 is filtered to ensure it meets all acceptable ranges. All groups 30 and 12 that do not meet acceptable ranges are tagged 38. Data that meets all requirements is left un-tagged. Tagged merged data indicates undesired material within bale 33. All processes 11, 30, 12, and 38 can be viewed live 28 within the local work station 15. All bales 33 are labeled with a bar code or unique identification number 7 that corresponds to the unique identification number assigned in 12. All times stamped 11, merged 30, identified 12, and filtered 8 data is saved in a local database 13. This data 11, 30, 12 and 38 is also sent via a wide area network 17 or comparable means of networking to be stored in a remote central database 18 that is contained within a remote server 29 to be accessed remotely as illustrated in FIG. 2.

FIG. 2 contains one embodiment or bale data search, observe and update. In FIG. 2 bales with barcodes 27 or numbered bales are scanned 26, the unique identification number 25 observed is entered into a remote work station. The remote workstation retrieves all bale data that matches the entered identification number 26 by communication through a wide area network 17 or comparable means of networking and accessing the bale data stored in the remote central database 18 that is housed in the remote server 29. This same search may be performed using alternative search fields 20 that include but are not limited to: waste supplier origin, initial baling origin, operator/operators present, baling date, baling time, carrier, transport time, and transport date. All search results are displayed on a computer monitor or comparable device that allows viewing of data. The search result displays all contents and environmental information about the bale(s) within the search field. Immediately following or if desirable, bale operational information may be updated by way of updatable operational fields 24. Operational information may be inputted automatically or manually. Updateable operational information may include but is not limited to current location, carrier name, termination and utilization. Once new operational information is inputted it is uploaded to the remote server's 29 remote central database 18 via a wide area network 17 or comparable means of networking.

### OPERATION

In operation users of our system can:

1) Monitor the refuse/materials 31 being packed into sealed bales 33 by observing all readings 28 on the monitor of the local work station 15. Bales that are contaminated with hazardous materials or undesirable materials will be tagged 38 and set aside to be brought to a proper facility; baler 32 operation is not delayed by this process.

2) Track and record contents of refuse/material bales 27. All completed bales 33 are marked or bar coded. The bar code found on each bale 33 and 27 is paired with video footage 39, material sensor/sensors data 10, and operational information 16 relevant to each bale processed. If a bale 27 is moved its location and other operational information can be updated 24. If a facility wants to know what is inside each bale they can retrieve that information from any remote workstation 19 by scanning the barcode on the questionable bale 27. When the barcode on a bale 27 is scanned all the contents of that bale can be observed through video footage 39 and material sensor data 35 along with a list of all its storage locations, handling employs, processing date, processing time, and an unlimitedly customizable list of attributes.

### CONCLUSION, RAMIFICATIONS, AND SCOPE

Accordingly the reader will see that the testing and tracking of sealed refuse bales can be used to ensure public and environmental safety in that:

It makes sealed refuse bale technology more valuable and viable by informing various public and private entities what precisely is in the bales without having to disassemble each bale;

It provides accurate and equitable traceability for those responsible in superfund sites;

It acts as a safeguard against hazardous waste materials being erroneously deposited in landfills;

It provides for accurate contents of seal refuse bales for transport over a plurality of public and private roadways and railways;

Although the description above contains many specificities, these should not be construed as limiting the scope of the embodiments but as merely providing illustrations of some of the presently preferred embodiments. For example, the system could also be used to test and track seal biomass bales, etc.

Thus the scope of the embodiments should be determined by the appended claims and their legal equivalents, rather than by the examples given.

1. A method for managing biomass and refuse material packed into bales, comprising:
a. Testing material attributes by means of a plurality of devices prior to processing in a plurality of bailing methods and apparatuses;
b. Providing a means of identifying said bales and the respective predetermined said material tributes;

2. A method for managing sealed refuse bale data, comprising:
a. Remote access via a plurality of internet or network devices;
b. Database for the storage of and retrieval of bale data;
